(19) United States
(12) Patent Application Publication
(10) Pub. No.: US 2026/0142267 A1
(43) Pub. Date: May 21, 2026

(54) HEATING ELEMENT AND SOLID STATE BATTERY COMPRISING THE SAME, AND METHODS OF MAKING AND OPERATING THEREOF

(71) Applicant: Ampcera Inc., Tucson, AZ (US)

(72) Inventors: Hui Du, Tucson, AZ (US); Eongyu Yi, Tucson, AZ (US); James Emery Brown, Tucson, AZ (US)

(21) Appl. No.: 19/327,299

(22) Filed: Sep. 12, 2025

Related U.S. Application Data
(60) Provisional application No. 63/720,898, filed on Nov. 15, 2024.

(51) Int. Cl. H01M 10/654; H01M 10/0562; H01M 10/615; H01M 10/653; H01M 10/6571

(52) U.S. Cl. CPC H01M 10/654; H01M 10/0562; H01M 10/615; H01M 10/653; H01M 10/6571; H01M 2200/106

(57) ABSTRACT

A solid-state battery comprising a positive electrode and a negative electrode, with a solid electrolyte layer positioned between them. The battery includes a positive current collector in electrical contact with the positive electrode and a negative current collector in electrical contact with the negative electrode. A heating element is situated in proximity to at least one of the current collectors, comprising a polymer substrate with a first surface and a second surface. A conductive oxide layer is disposed on the first surface of the polymer substrate, with first and second metal electrodes positioned on the conductive oxide layer. An electrical insulation layer is also provided on the conductive oxide layer, positioned between the first and second metal electrodes to ensure efficient and controlled heating within the solid-state battery.

### PRIORITY

This application claims the benefit of U.S. Provisional Ser. No. 63/720,898, filed Nov. 15, 2024, the entire contents of which are hereby incorporated by reference herein.

### GOVERNMENT RIGHTS

This invention was made with Government support under DE-AR0001731 awarded by Advanced Research Projects Agency-Energy (ARPA-E). The government has certain rights in the invention.

### FIELD

The present application relates to the field of solid-state batteries, specifically to thermal management systems within solid-state battery assemblies that enhance battery performance and longevity.

### BACKGROUND

Solid-state batteries (SSBs) represent a significant advancement in energy storage, offering higher energy density, improved safety, and longer lifespans compared to traditional lithium-ion batteries. However, one of the challenges in SSB operation lies in maintaining optimal temperature conditions across the battery stack, as temperature variations can impact the ionic conductivity of the solid electrolyte, affecting battery performance, efficiency, and lifespan.

Various heating strategies have been explored to address these thermal challenges. Conventional approaches often rely on metallic heating elements, such as patterned foils or serpentine traces of copper, nickel, or other conductive metals, integrated within or adjacent to the battery stack. While such metal-based heaters can provide resistive heating, they typically require complex patterning to achieve useful resistance values, since metals inherently exhibit very low resistivity. These patterned structures can introduce non-uniform pressure profiles, localized hot spots, or mechanical discontinuities that may negatively affect SSB performance and durability.

Accordingly, those skilled in the art continue with research and development in the field of integrated thermal management solutions for SSBs, focusing on designs that provide uniform heating across the battery stack, particularly under cold-start or sustained high-performance conditions. The aim is to improve thermal regulation without compromising the structural integrity or electrical performance of the battery, thereby advancing SSB technology for a range of applications.

### SUMMARY

In one example, a solid-state battery is provided, comprising a positive electrode and a negative electrode with a solid electrolyte layer positioned between them. The battery includes a positive current collector in electrical contact with the positive electrode and a negative current collector in electrical contact with the negative electrode. A heating element may be positioned in proximity to at least one of the current collectors, wherein the heating element comprises a polymer substrate with a first surface and a second surface. A conductive oxide layer is disposed on the first surface of the polymer substrate, and first and second metal electrodes are positioned on the conductive oxide layer. An electrical insulation layer is also provided on the conductive oxide layer, positioned between the first and second metal electrodes to ensure efficient and controlled heating within the solid-state battery.

In other examples, the polymer substrate of the heating element may be selected from a variety of materials, such as thermoset polymers, thermoplastic polymers, elastomeric polymers, composite polymers, porous polymers, high-temperature polymers, or multilayer polymer substrates, each providing specific advantages in solid-state battery applications.

In further examples, the conductive oxide layer may be formed from materials such as indium tin oxide (ITO), fluorine-doped tin oxide (FTO), aluminum-doped zinc oxide (AZO), antimony-doped tin oxide (ATO), vanadium oxide (VOx), or graphene oxide, selected for their resistive heating and thermal stability characteristics.

Additional examples may include the use of metal electrodes fabricated from materials such as copper, aluminum, silver, nickel, platinum, or palladium, each contributing to reliable electrical contact and heat distribution.

In further aspects, methods are provided for fabricating the heating element, including depositing a conductive oxide layer on a polymer substrate, forming first and second metal electrodes on the conductive oxide layer, and applying an electrical insulation layer between the electrodes. Additional methods are directed to operating a solid-state battery that incorporates the heating element, including applying a voltage across the electrodes to generate resistive heating, regulating temperature by adjusting the applied voltage, and monitoring resistance changes of the conductive oxide layer to provide temperature feedback. Such methods enable efficient temperature control across the solid-state battery stack, improve ionic conductivity of the solid electrolyte, and enhance battery performance under cold-start and sustained high-power conditions.

Other aspects will become apparent from the following detailed description, the accompanying drawings, and the appended claims.

### BRIEF DESCRIPTION OF THE DRAWINGS

FIG. 1: A schematic view of the heating element assembly, illustrating the multi-layered configuration with a polymer substrate (4), a conductive oxide layer (6), metal electrodes (8), and an electrical insulation layer (10).

FIG. 2: A diagram of the heating element integrated within an SSB configuration, showing first and second current collectors (12) in contact with the heating element for efficient thermal management across the battery stack.

FIG. 3: A cross-sectional view of a multi-cell solid-state battery (14), illustrating the heating element (2) positioned between adjacent current collectors (12) of neighboring cells, each cell including a positive electrode (16), a solid electrolyte layer (18), and a negative electrode (20). Variations are contemplated in which the heating element is disposed between two positive current collectors or two negative current collectors, in an anodeless architecture, or within a hybrid design incorporating both solid and liquid electrolytes.

### DETAILED DESCRIPTION

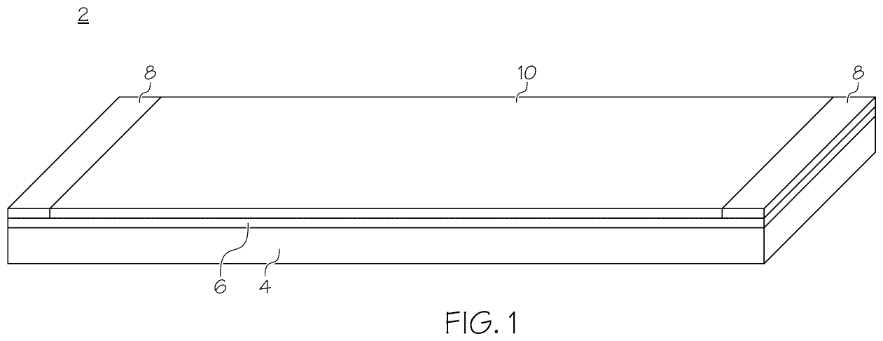

The present description pertains to a heating element designed for use in solid-state battery (SSB) applications. As shown in FIG. 1, this heating element (2) comprises a multi-layered assembly comprising a polymer substrate (4) as a foundational base, a conductive oxide layer (6) on the polymer substrate, a pair of metal electrodes (8) on the conductive oxide layer, and an electrical insulation layer (10) on the conductive oxide layer between the metal electrodes. Each component of this assembly is further described below.

Polymer Substrate: The polymer substrate serves as the foundational base of the heating element, supporting the conductive oxide layer and stabilizing the entire assembly. This substrate may also, depending on the material properties of the substrate, function as a pressure uniforming layer. In this context, pressure uniforming refers to the substrate's ability to distribute compressive forces evenly across the solid-state battery (SSB) stack. By doing so, the substrate minimizes variations in pressure that can lead to gaps, uneven contact, or stress concentrations between layers of the battery assembly. A well-distributed, uniform pressure ensures consistent contact across the layers, improving electrical conductivity and thermal performance. Materials with elastic or compressible properties can conform to surface irregularities and create a more uniform interface between battery layers, which helps maintain optimal performance and prolongs the battery's operational life. The thickness of this substrate can range widely, from less than 1 micron to several millimeters, allowing for flexibility in its structural and functional role in SSB applications. In some embodiments, it may specifically range from about 1 microns to 500 microns, with variations to accommodate both flexible and rigid substrate requirements.

Thermoset Polymer Substrate: The thermoset polymer substrate is a specific type of polymer substrate characterized by its rigidity and resistance to deformation, especially under elevated temperatures. Unlike thermoplastic materials, thermosets harden permanently upon curing, providing a stable and durable base for applications requiring long-term mechanical stability. This feature is beneficial in solid-state battery (SSB) applications, where stable structural support is desired for maintaining consistent pressure and alignment across the heating element layers. Thermoset substrates resist thermal and mechanical stress, making them ideal for high-performance environments. Thermoset polymer substrates can be composed of various materials, such as epoxy, phenolic resin, or polyimide, each offering unique advantages depending on the application. For example, epoxy-based thermosets provide excellent chemical resistance and bonding capabilities, while phenolic resins are highly resistant to heat and mechanical wear. Polyimide thermosets offer superior thermal stability, withstanding temperatures up to approximately 300° C. without significant degradation. This thermal resilience ensures the substrate can support the heating element effectively, even in high-temperature SSB environments. Other suitable thermoset materials for SSB applications include silicone resins, which offer flexibility and excellent electrical insulation; bismaleimide (BMI) resins, known for high-temperature performance and mechanical strength; cyanate ester resins, prized for their low moisture absorption and dimensional stability; polybenzoxazine resins, which provide high thermal stability and flame resistance; and melamine-formaldehyde resins, offering hardness and surface durability. These thermoset options allow for tailored thermal, mechanical, and chemical properties, ensuring compatibility with specific performance demands within the solid-state battery heating element. The thickness of thermoset polymer substrates can vary widely, typically ranging from about 10 microns to 1,000 microns. This range allows for customization based on specific structural needs, with thinner layers offering a lighter, more flexible support option and thicker layers providing added rigidity for heavy-duty applications. In some embodiments, a thermoset substrate thickness may range from 50 microns to 500 microns, providing an optimal balance between mechanical strength and manageable thickness for assembly. Thermoset substrates are also chosen for their dimensional stability, which ensures minimal expansion or contraction with temperature fluctuations. This property contributes to maintaining consistent pressure across the SSB stack, preventing potential performance issues caused by structural shifts in the heating element. Consequently, thermoset polymer substrates provide both the foundational support and the thermal stability needed for reliable operation within solid-state battery applications.

Thermoplastic Polymer Substrate: The thermoplastic polymer substrate is a flexible and adaptable material, ideal for applications that require structural support as well as effective pressure distribution within the solid-state battery (SSB) heating element. Unlike thermoset polymers, thermoplastic polymers can soften when heated and resolidify upon cooling, allowing for reshaping and providing improved adaptability under variable conditions. This flexibility is particularly advantageous in SSB assemblies, where it facilitates even distribution of compressive forces across the battery stack, enhancing pressure uniformity and ensuring consistent contact between layers. Several thermoplastic materials are suitable for use in SSB applications. For instance, Polyethylene Terephthalate (PET) offers strong dimensional stability and resistance to chemicals, making it an excellent choice for environments where the battery may encounter exposure to various substances. Low-Density Polyethylene (LDPE) may be selected for its flexibility and impact resistance, which are beneficial in applications requiring mechanical resilience. Polytetrafluoroethylene (PTFE), on the other hand, may be selected for its high temperature tolerance and low-friction properties, enabling it to perform effectively under extreme operating conditions, often up to 260° C. Other suitable thermoplastic materials for SSB applications include polypropylene (PP) for its chemical resistance and low moisture absorption, polyvinylidene fluoride (PVDF) for high thermal stability and chemical resilience, nylon for its toughness and wear resistance, polycarbonate (PC) for its impact strength and transparency, polyether ether ketone (PEEK) for exceptional thermal and mechanical stability, and ethylene-vinyl acetate (EVA) for flexibility and durability in low-temperature applications. These materials offer a wide range of thermal, mechanical, and chemical properties that can be tailored to specific requirements within the solid-state battery heating element. The typical thickness range for thermoplastic substrates in SSB applications spans approximately 1 micron to 20 microns; however, a broader range, extending up to 200 microns, may be employed to meet specific structural or pressure uniforming requirements. For applications needing greater flexibility, thinner layers may be selected, while thicker thermoplastic layers provide additional structural support and stability. In addition to their flexibility and range of thicknesses, thermoplastic substrates play a significant role in addressing issues related to pressure variations and uneven contact between battery layers. When compressed, the thermoplastic substrate can conform to minor surface irregularities, providing a more uniform interface across layers. This conformity improves both electrical conductivity and thermal performance in the SSB stack, supporting efficient and consistent battery operation. Thermoplastic substrates also resist chemical degradation and moisture ingress, which contributes to their longevity and stability in harsh environments. Thermoplastic substrates typically operate effectively within temperature ranges up to approximately 150° C., depending on the specific polymer. This characteristic makes them suitable for moderate thermal conditions commonly encountered in SSB applications. By combining flexibility, resilience, and thermal stability, thermoplastic polymer substrates provide an ideal solution for achieving both structural integrity and pressure uniformity in solid-state battery heating elements.

Elastomeric Polymer Substrate: The elastomeric polymer substrate is a type of polymer substrate designed to enhance pressure distribution across the solid-state battery (SSB) stack due to its elastic and compressible properties. By evenly distributing compressive forces, the substrate helps reduce the likelihood of localized stress or inconsistent contact between layers. This distribution can support improved electrical conductivity and thermal performance within the SSB stack. Materials suitable for the elastomeric polymer substrate include Nitrile Butadiene Rubber (NBR), which provides compressibility, resilience, and chemical resistance, enabling it to perform under varied conditions, including exposure to oils and other chemicals, while retaining elasticity at moderate temperatures. Additional materials that may be used for this purpose include silicone rubber, which offers stability at elevated temperatures and dielectric properties; ethylene propylene diene monomer (EPDM), which is resistant to weathering and UV exposure; fluorocarbon rubber (FKM), for its chemical and thermal resistance; and thermoplastic elastomers (TPEs), which combine rubber-like elasticity with processing benefits. The elastomeric polymer substrate can be configured in thicknesses ranging from about 10 microns to 1,000 microns, selected based on the desired level of compressibility and support for specific applications. Thinner layers, around 10 to 100 microns, may be implemented where minimal thickness is advantageous, while thicker layers, up to 1,000 microns, can provide increased force distribution and stability under greater mechanical demands. In addition to distributing pressure and conforming to surface irregularities, the elastomeric substrate may exhibit strong durability under repeated compression, helping to maintain a stable interface between battery layers and reduce potential wear. The flexibility and rebound characteristics of elastomeric materials can also support consistent contact and structural integrity, even as minor shifts in the battery layers occur during operation. Elastomeric polymer substrates are generally suited to operate within moderate temperature ranges, often up to approximately 150° C., depending on the specific elastomer. This combination of temperature resilience, compressibility, and flexibility makes the elastomeric polymer substrate a suitable option for achieving uniform pressure distribution and reliable support in solid-state battery heating elements.

Composite Polymer Substrate: The composite polymer substrate is a multi-material substrate engineered to provide structural and thermal benefits, enhancing the stability and heat management properties of the solid-state battery (SSB) assembly. By integrating different materials such as various polymers, fibers, or fillers like glass, carbon, or ceramic particles, this substrate achieves properties that single-material polymers alone may not provide. These combinations contribute to increased thermal stability, mechanical strength, and resistance to environmental factors, making composite substrates suitable for SSB applications where effective thermal management and robust structural support are desired. Depending on the specific materials used, composite substrates can offer properties such as enhanced rigidity, low thermal expansion, or improved heat dissipation, which aid in managing the thermal profile across the battery stack. For example, incorporating glass or ceramic fillers enhances thermal stability and mechanical durability, while polymer blends can provide additional flexibility or impact resistance. Certain composite structures can be engineered to offer varying thermal conductivities across layers, which assists in managing localized heat within the SSB heating element. Composite polymer substrates are typically fabricated in thicknesses ranging from approximately 10 microns to 2,000 microns. In applications requiring lightweight flexibility, thinner composite layers—around 10 to 100 microns—may be employed. In contrast, thicker layers, up to 2,000 microns, may be used in applications where added structural stability and advanced thermal management are essential. Beyond thermal and structural benefits, composite substrates exhibit dimensional stability, maintaining consistent layer alignment and pressure distribution in the SSB assembly even under varying temperature conditions. By tailoring material combinations to meet specific thermal and structural demands, composite polymer substrates offer a versatile solution for solid-state battery applications, providing reliable support and effective thermal control within the heating element.

Porous Polymer Substrate: The porous polymer substrate is a type of substrate characterized by its porous structure, which may be achieved through methods such as perforation, foam formation, or the inclusion of porous fillers. The substrate can be configured with closed-cell or open-cell pore structures, with pore size and distribution tailored to specific functional needs. Porous polymer substrates may be typically made from materials such as polyethylene (PE), polyurethane (PU), polyvinylidene fluoride (PVDF), and expanded polytetrafluoroethylene (ePTFE), each offering distinct physical and chemical properties suited for various operational environments. Thicknesses of porous polymer substrates can range from approximately 10 microns to 1,500 microns, with specific thicknesses selected based on the desired balance between structural support and flexibility. A function of the porous polymer substrate in solid-state battery (SSB) applications is to facilitate pressure uniformity across the battery stack. The compressible, adaptable nature of the porous structure allows the substrate to evenly distribute compressive forces throughout the layers, minimizing localized stress points and enhancing consistent contact across interfaces. This uniform distribution of pressure helps maintain the mechanical stability and reliability of the battery, contributing to optimal performance over extended periods. In addition to pressure uniforming, the porous structure can provide secondary functions. For example, by permitting airflow or heat dissipation through the battery stack, the substrate may aid in thermal management where needed. Furthermore, the porous design contributes to weight reduction, making it advantageous in applications where minimizing overall mass is a priority. By combining pressure uniforming with potential thermal and weight benefits, the porous polymer substrate offers a versatile solution adaptable to various demands within the solid-state battery heating element.

High-Temperature Polymer Substrate: The high-temperature polymer substrate is a type of substrate designed to withstand elevated temperatures, providing stable structural support and thermal resilience within the solid-state battery (SSB) assembly. This substrate may be typically made from polymers that are engineered to resist degradation or deformation at high temperatures, ensuring reliable performance under thermal stress. High-temperature polymer substrates can be composed of materials such as polyimide, polyether ether ketone (PEEK), polyphenylene sulfide (PPS), and certain fluoropolymers, each selected for their thermal stability and mechanical properties. These materials enable the high-temperature polymer substrate to retain its structural integrity in operating conditions that may reach or exceed 300° C., depending on the specific polymer composition. For example, polyimide substrates can maintain stability and strength at temperatures up to approximately 350° C., making them suitable for high-performance applications. PEEK and PPS, similarly, offer high mechanical strength and resistance to thermal and chemical degradation, making them well-suited for environments with demanding thermal profiles. The thickness of high-temperature polymer substrates can vary significantly, typically ranging from about 10 microns to 1,000 microns. This range accommodates various structural and thermal requirements, with thinner layers (e.g., 10 to 100 microns) providing flexible support in applications requiring minimal material mass, while thicker layers (up to 1,000 microns) offer enhanced mechanical stability and thermal insulation for applications subjected to extended or extreme heat exposure. In addition to thermal resistance, high-temperature polymer substrates often exhibit excellent dimensional stability, maintaining consistent shape and thickness even under fluctuating temperatures. This stability helps maintain consistent pressure across the SSB stack and prevents the potential misalignment of layers, which is crucial for the reliable operation of the heating element. Certain high-temperature polymers also provide resistance to chemical degradation, further enhancing the durability and operational lifespan of the SSB assembly in harsh environments. By combining thermal resilience, dimensional stability, and robust structural support, high-temperature polymer substrates offer a reliable solution for solid-state battery heating elements that require sustained performance in high-temperature applications.

Multilayer Polymer Substrate: The multilayer polymer substrate is a type of substrate designed with multiple polymer layers, each tailored to provide specific structural, thermal, or mechanical properties. This layered construction allows for a combination of diverse material characteristics within a single substrate, offering enhanced versatility and customization options within the solid-state battery (SSB) assembly. Multilayer substrates may be constructed by laminating or co-extruding multiple polymer films, enabling fine-tuning of properties such as flexibility, thermal stability, and impact resistance to meet the unique demands of SSB applications. Each layer within a multilayer polymer substrate can be composed of different materials, such as polyimide, polyethylene terephthalate (PET), polyether ether ketone (PEEK), polycarbonate (PC), or fluoropolymers. For instance, one layer might prioritize thermal stability using polyimide or PEEK, while another layer provides flexibility using PET or PC, creating a substrate that balances rigidity and adaptability. Additional layers may include specific materials for added chemical resistance, thermal insulation, or improved mechanical strength. The multilayer construction allows these substrates to withstand varied operating conditions within the SSB stack, such as high temperatures, exposure to chemicals, or mechanical stress, without compromising their structural integrity. Thicknesses of multilayer polymer substrates are highly adaptable, typically ranging from approximately 10 microns to 2,000 microns, depending on the number of layers and the thickness of each layer. Thinner configurations, from about 10 to 100 microns, may be selected for applications requiring lightweight flexibility, while thicker configurations, up to 2,000 microns, provide enhanced support and stability for more demanding applications. In addition to their structural and thermal benefits, multilayer polymer substrates can offer dimensional stability across temperature fluctuations, minimizing expansion or contraction and helping maintain consistent alignment and pressure within the SSB stack. By combining multiple materials with complementary properties, these substrates provide a balanced approach to supporting and insulating the heating element while adapting to the operational needs of the battery. Through their layered design, multilayer polymer substrates offer a reliable and customizable solution for solid-state battery heating elements, achieving a tailored balance of mechanical strength, thermal resistance, and flexibility suited to varied SSB applications.

Conductive Oxide Layer: The conductive oxide layer in this heating element plays a central role in providing resistive heating across the solid-state battery (SSB) stack. Conductive oxides are materials that exhibit both electrical conductivity and thermal stability, making them well-suited for applications requiring controlled heating. These materials typically maintain their conductive and structural properties even under variable thermal conditions. In the context of solid-state battery applications, conductive oxides can be divided into metal oxides, such as indium tin oxide (ITO) and fluorine-doped tin oxide (FTO), and non-metal oxides, such as graphene oxide. Metal oxides, typically formed by doping with specific elements, combine conductivity with durability, ensuring effective heat distribution and stability at higher temperatures. Non-metal oxides, like graphene oxide, provide unique properties such as high thermal conductivity and flexibility, which can be advantageous in applications where lightweight, adaptable materials are needed. Conductive oxides can be engineered to exhibit specific resistive and thermal characteristics, making them essential components in SSB heating elements, where consistent temperature regulation is critical for maintaining battery efficiency and performance.

Material Composition and Options: The conductive oxide layer in the heating element may be composed of a variety of materials, each chosen for its unique properties that enhance heating performance, durability, and overall efficiency in solid-state battery (SSB) applications. Common choices include both metal oxides and non-metal oxides, with each material offering particular benefits and trade-offs. Indium tin oxide (ITO) is a widely used metal oxide that combines electrical conductivity, thermal stability, and chemical resistance, making it an ideal choice for heating elements where durability at high temperatures is essential. Its ability to maintain conductivity over prolonged use in demanding environments makes ITO a strong candidate, although the cost of indium can increase production expenses. Similarly, fluorine-doped tin oxide (FTO) provides low electrical resistivity and excellent durability under both thermal and chemical stresses. FTO is generally more cost-effective than ITO while delivering comparable conductive performance, making it suitable for high-temperature applications in SSB heating components. Another viable option is aluminum-doped zinc oxide (AZO), which offers good electrical conductivity and thermal resilience at a lower cost compared to ITO. AZO's strong chemical stability and resistance to high temperatures make it useful for cost-sensitive applications, though it may have slightly lower conductivity than ITO or FTO depending on the specific requirements. Antimony-doped tin oxide (ATO) is also considered for its high thermal stability and low sheet resistance, which support reliable heat generation and extended longevity under varying environmental conditions. As an alternative to ITO, ATO is advantageous for applications needing high performance with a focus on cost-efficiency, though its conductivity may be somewhat less than that of ITO or FTO. Vanadium oxide (VOx) offers additional flexibility, with resistive properties that can be tuned to achieve precise temperature control. This adaptability is beneficial for applications requiring customized thermal management profiles. While VOx provides strong control over resistive heating, its stability under prolonged high-temperature exposure may be lower than that of other metal oxides. Graphene oxide, a non-metal oxide, introduces distinct advantages including high thermal conductivity, flexibility, and lightweight characteristics. These properties make it suitable for applications needing minimal thickness and adaptability, although graphene oxide's conductive consistency can vary based on processing methods, which may impact integration into SSB components. Each material offers specific advantages for heating elements in solid-state batteries. The selection of the conductive oxide material, or a combination of materials, is provided for customizing the layer's resistivity, thermal control, and overall cost-effectiveness.

Thermal Stability and Operating Temperature Ranges: The thermal stability of the conductive oxide layer plays a significant role in its performance, particularly in solid-state battery (SSB) applications where operating temperatures can range from 150° C. to 400° C., depending on the specific battery design and intended application. Conductive oxides such as indium tin oxide (ITO), fluorine-doped tin oxide (FTO), and aluminum-doped zinc oxide (AZO) are selected for their ability to maintain their structural and conductive properties at elevated temperatures, which supports the consistent functionality of the heating element throughout the battery's operational life. In SSBs, which may be subject to prolonged heating cycles and varying loads, materials that retain conductivity and structural integrity under high temperatures can help provide steady resistive heating, facilitating efficient thermal management within the battery stack. In contrast, materials with lower thermal stability may degrade or undergo conductivity changes, potentially leading to uneven heating or thermal hotspots that could affect battery operation. Applications requiring extended heating, such as in electric vehicles or industrial equipment, benefit from materials with high thermal resilience, as they help sustain reliable performance over time by preventing shifts in resistance or structural breakdown. Furthermore, under conditions where load changes may cause rapid cycling of temperature, a thermally stable oxide layer helps avoid issues like expansion and contraction that can lead to cracking or delamination from the polymer substrate. By selecting conductive oxides with high thermal stability, such as ITO, FTO, and ATO, the heating element can deliver consistent temperature regulation across a variety of conditions, supporting the reliable operation and durability of the SSB. This stability contributes to the longevity and efficiency of solid-state batteries, enabling the conductive oxide layer to withstand demanding operational environments and extended usage without impacting the heating element's performance.

Fabrication Techniques and Layer Uniformity: The conductive oxide layer can be fabricated using various deposition methods that ensure a uniform and durable application across the polymer substrate. Typical deposition techniques include sputtering, physical vapor deposition (PVD), and chemical vapor deposition (CVD), each chosen for its ability to produce a consistent, adherent oxide layer with precise thickness control, a key factor in achieving reliable resistive heating performance in solid-state battery (SSB) applications. Sputtering is frequently used for depositing thin films of conductive oxides, where high-energy particles eject material from a target, coating the substrate in a controlled manner. This method allows for the precise layering of materials such as indium tin oxide (ITO) and fluorine-doped tin oxide (FTO) at various thicknesses, supporting uniform heating performance. Sputtering is especially advantageous for thin, even coatings that maintain structural and electrical integrity over prolonged use. Physical Vapor Deposition (PVD) provides another approach, involving the vaporization of the oxide material, which then condenses onto the substrate to form a uniform film. PVD is effective for creating dense, adherent layers of conductive oxides, ideal for applications requiring stable resistive properties across the layer's surface. This technique allows for high levels of control over film thickness and deposition rates, resulting in a reliable and repeatable process. Chemical Vapor Deposition (CVD) is also applicable, particularly for complex layer compositions or when uniform coverage over irregular surfaces is required. In CVD, gaseous reactants deposit the oxide onto the substrate, enabling the formation of conductive films with high uniformity and durability. CVD may be used to apply materials like aluminum-doped zinc oxide (AZO) and antimony-doped tin oxide (ATO), where stability and surface conformity are desired. In addition to these techniques, commercially available substrates with pre-applied conductive oxide layers, such as ITO or FTO-coated polymer films, may also be used as foundational layers in SSB applications. These pre-coated substrates offer a cost-efficient option for integrating conductive oxides without requiring direct deposition, supporting streamlined manufacturing processes while ensuring consistency in layer uniformity and resistive properties. Such commercially available options are often scalable and cost-effective, simplifying fabrication for applications where the conductive oxide layer specifications match those of available materials. Through these fabrication methods and substrate options, the conductive oxide layer can be applied with a high degree of uniformity, enhancing the reliability and performance of the heating element in solid-state batteries.

Sheet Resistance and Heating Efficiency: The sheet resistance of the conductive oxide layer directly impacts heating efficiency and thermal control within the solid-state battery (SSB) heating element. Measured in ohms per square centimeter (Ω/sq), sheet resistance quantifies the resistance to current flow across the oxide layer's surface. In SSB applications, sheet resistance may be selected to range from about 1 to 1,000 Ω/sq, depending on the heating characteristics and operational needs. Lower sheet resistance values, in the range of about 1 to 100 Ω/sq, permit higher current flow through the conductive oxide layer, generating increased heat output for a given applied voltage. This heat output range can be advantageous in applications requiring rapid temperature rises, such as when batteries need to reach operational temperatures quickly. Conversely, higher sheet resistance values, typically in the range of about 100 to 1,000 Ω/sq, facilitate more gradual and controlled heating, which can help maintain stable and sustained temperatures over extended periods or meet applications that benefit from slower thermal modulation. The ability to control sheet resistance within this range allows for the development of thermal profiles that meet specific SSB requirements. For instance, in applications requiring a quick start-up, a lower sheet resistance may be selected to facilitate fast heating. For consistent operational temperatures, a higher sheet resistance might be preferable, helping to avoid excessive heating and manage energy consumption effectively. A conductive oxide layer with optimized sheet resistance also supports uniform heating across the layer, which can prevent localized hot spots and help maintain an even thermal environment within the battery stack. By adjusting the sheet resistance to align with particular heating needs, the conductive oxide layer provides precise temperature control, supporting the efficiency and performance of solid-state batteries across diverse operating conditions.

Doping and Performance Tuning: Doping of conductive oxides, such as indium tin oxide (ITO), provides a method for fine-tuning the electrical properties of the conductive oxide layer, enabling adjustments to conductivity and resistance to meet specific performance requirements. By introducing controlled amounts of dopants—such as varying the concentration of tin within ITO—the layer's sheet resistance and overall conductivity can be modified to produce precise heating characteristics suitable for solid-state battery (SSB) applications. For instance, increasing the concentration of tin in ITO generally reduces its resistance, thereby enhancing conductivity and allowing for more rapid heat generation under an applied voltage. This lower resistance profile can be beneficial for applications that require fast, responsive heating, such as in systems where the battery needs to reach operating temperatures quickly. Conversely, reducing the tin concentration results in higher resistance, which supports a slower, more controlled heat output, making it well-suited for applications that need steady, sustained temperatures over longer periods. Beyond ITO, other conductive oxides, such as fluorine-doped tin oxide (FTO) and aluminum-doped zinc oxide (AZO), can similarly be tuned by adjusting the levels of fluorine or aluminum, respectively. This customization allows the conductive oxide layer to achieve a balance between responsiveness and stability, adapting the heating profile to match the thermal needs of the SSB application. By tailoring doping levels, manufacturers can create conductive oxide layers with a range of resistive heating characteristics, offering flexibility in the design of the SSB heating element. This flexibility supports optimized energy usage and efficient thermal management across different operational scenarios, ensuring that the heating element meets the specific demands of the solid-state battery system.

Layer Thickness and Functional Impact: The thickness of the conductive oxide layer in the heating element typically ranges from 5 nanometers to about 10 micron, with specific thicknesses selected to meet the heating performance requirements of solid-state battery (SSB) applications. The thickness of this layer plays a key role in determining how quickly and effectively the layer responds to voltage changes, allowing for tailored heating characteristics based on application demands. Thinner layers, generally in the range of 5 to 100 nanometers, tend to have lower thermal mass, enabling them to respond more rapidly to applied voltage changes. This characteristic is advantageous in applications requiring quick temperature adjustments, such as rapid-start systems where the battery must reach operating temperature swiftly. The reduced thickness also facilitates energy efficiency, as less energy is required to heat a smaller volume, making it suitable for applications prioritizing fast and efficient thermal response. Conversely, thicker layers—typically between 100 nanometers and 10 micron—provide a more sustained and stable heating output. The additional material in a thicker layer helps maintain a steady temperature over extended periods, making it beneficial in applications that require consistent, prolonged heating. This stability reduces the likelihood of temperature fluctuations, supporting uniform thermal management within the SSB stack, which is essential in applications with extended operational cycles or continuous heating needs. By selecting the appropriate layer thickness, the conductive oxide layer can be optimized to deliver either rapid response or sustained heating, depending on the specific performance requirements. This customization in layer thickness offers flexibility in designing the SSB heating element, ensuring that the heating profile aligns with the operational demands of the solid-state battery system.

Patterning and Pressure Distribution: In addition to electrical considerations, the extent of patterning within the heating element can affect the mechanical interface between layers of the solid-state battery (SSB) stack. Conventional metallic foil heaters often require serpentine or meander-type geometries to achieve suitable resistance, which introduce raised edges and patterned voids across the heater footprint. These features can lead to non-uniform contact pressures within the stack, resulting in localized stress points or gaps that disrupt ionic conduction and thermal transfer. By contrast, conductive oxides can be engineered to exhibit resistances within a desired range even when deposited as a substantially continuous film, or with only minimal patterning. The reduced reliance on serpentine structures enables a smoother, more uniform layer profile that distributes compressive forces evenly across adjacent SSB layers. This mechanical uniformity helps maintain consistent electrode-electrolyte contact, avoids localized delamination, and promotes both electrochemical and thermal stability during cycling.

Simplified Integration: Because conductive oxides can deliver resistive heating performance without extensive patterning, the deposition and integration steps may also be simplified. Continuous or near-continuous oxide coatings eliminate the need for intricate etching or printing processes, reducing edge defects that might otherwise act as stress concentrators under stack compression. As a result, conductive oxide heating elements can simultaneously enhance manufacturability and improve pressure uniformity within the battery assembly.

Temperature Coefficient of Resistance (TCR): In certain embodiments, the conductive oxide layer exhibits a positive temperature coefficient of resistance (TCR), such that its electrical resistance increases with increasing temperature. The TCR may be in the range of about +500 to +3500 ppm/°C. between 25° C. and 200° C. This property enables the conductive oxide layer to provide both heating and temperature feedback, since resistance measurements can be correlated with layer temperature. The positive TCR also reduces the risk of runaway heating by naturally limiting current flow as temperature rises, contributing to stable thermal management of the solid-state battery stack.

Continuous Conductive Oxide Film: In certain embodiments, the conductive oxide layer is deposited or otherwise formed as a substantially continuous film across the surface of the polymer substrate. For purposes of this disclosure, a “continuous film” refers to a coating or layer that extends over the substrate without large patterned voids or serpentine trace geometries, such that the film presents an essentially uninterrupted contact surface to the adjacent layers of the solid-state battery (SSB) stack. While minor discontinuities (e.g., micro-scale grain boundaries or pinholes inherent to thin-film deposition processes) may be present, the film is continuous in the sense that it does not include macroscopic cut-outs or meander patterns typical of metal foil heaters.

The continuous film configuration provides distinct advantages within the SSB stack. Unlike patterned serpentine metallic heaters, which create raised edges and open void regions that can lead to uneven compressive forces and require filler material to restore planarity, a continuous conductive oxide film establishes a smooth, uniform layer that distributes pressure evenly across adjacent electrodes, electrolytes, and current collectors. This uniform pressure profile helps maintain consistent electrode-electrolyte contact, reduces the likelihood of localized delamination or stress concentrations, and eliminates the need for additional filler or leveling steps during assembly. Furthermore, because conductive oxides exhibit higher resistivity than metals, suitable sheet resistance can be achieved in a continuous film without resorting to intricate patterning, thereby simplifying fabrication while simultaneously improving mechanical uniformity in the SSB stack.

Interface and Adhesion Enhancements: In certain configurations, an intermediate adhesion layer may be applied between the polymer substrate and the conductive oxide layer to enhance bonding and prevent delamination. Materials commonly used for this adhesion layer include thin films of titanium or silicon dioxide, both of which offer strong adhesive properties that improve the durability and stability of the conductive oxide layer on the substrate. This additional layer serves to anchor the conductive oxide more securely to the polymer base, which is particularly beneficial in high-stress or high-temperature environments where differences in thermal expansion between the layers could otherwise cause separation. The adhesion layer effectively mitigates these thermal and mechanical stresses, maintaining the integrity of the oxide layer even under fluctuating temperature or load conditions. In high-temperature applications, the adhesion layer also contributes to thermal stability, helping to prevent peeling or cracking of the conductive oxide layer that may occur due to repeated heating and cooling cycles. By reinforcing the bond between the conductive oxide and polymer substrate, the adhesion layer enhances the long-term reliability of the heating element, supporting consistent performance and minimizing the risk of failure due to layer detachment.

Metal Electrodes: The metal electrodes in the heating element are components responsible for conducting electrical current across the conductive oxide layer, forming a complete heating circuit within the solid-state battery (SSB) assembly. Positioned on the conductive oxide layer, these electrodes create points of electrical input and output, allowing current to flow and generate heat within the heating element. The metal electrodes are designed to ensure reliable electrical contact with the conductive oxide, supporting efficient and controlled heat distribution across the battery stack. Structurally, metal electrodes are typically thin films or patterned lines that cover designated areas on the conductive oxide layer, leaving sufficient spacing to define the current path. This structure can vary based on the specific application requirements, ranging from simple strip patterns to geometries that optimize current flow and heating efficiency. In some configurations, the electrodes may be applied as continuous coatings, while in others, they may consist of discrete segments or grids to control heating zones. Various fabrication methods can be employed to create the metal electrodes, allowing flexibility in manufacturing based on the required precision, cost, and scalability. Techniques such as physical vapor deposition (PVD) and sputtering are often used to apply thin, uniform films of conductive metal directly onto the oxide layer. These methods offer excellent adhesion and precision, especially for high-performance applications. Alternatively, techniques like screen printing, painting, and inkjet printing allow for direct patterning of metallic inks or coatings onto the oxide layer, enabling cost-effective production and customized electrode designs. For thicker electrodes, casting techniques may be employed, providing greater durability and conductivity where needed. The choice of metal for the electrodes is another consideration, as it directly influences conductivity, cost, and durability. Common materials include silver, known for its excellent conductivity, as well as gold, which offers corrosion resistance and stable performance over time. Copper is widely used for its high conductivity and cost-effectiveness, while aluminum offers a lightweight and corrosion-resistant alternative. Additional metals that may be used include platinum, palladium, nickel, chromium, and tungsten, each chosen based on specific needs such as high-temperature stability, resistance to environmental degradation, or compatibility with the conductive oxide layer. By selecting appropriate materials and fabrication techniques, the metal electrodes can be tailored to meet the specific requirements of the SSB heating element, ensuring optimal electrical contact and efficient heating performance. These electrodes play a critical role in directing current flow and achieving the desired heating profile, supporting the reliable and consistent operation of the solid-state battery system.

Electrical Insulation Layer: The electrical insulation layer in an SSB heating element prevents electrical shorting between electrodes and can aid in distributing pressure uniformly across the battery stack, supporting consistent contact and performance. The materials used in this layer may be similar in functionality and composition to those described for the polymer substrate (see section on substrate materials) and can range from thermosets to thermoplastics, elastomers, composites, and high-temperature or porous structures.

Thermoset Insulation Materials (e.g., epoxy, polyimide, silicone resins) provide permanent rigidity and thermal stability, performing well under high temperatures (up to 300° C. for polyimide) with excellent chemical resistance. These materials, similar to thermoset substrates, are available in thicknesses from 10 to 1,000 microns for options from flexible support to robust insulation.

Thermoplastic Insulation Materials (e.g., PET, PTFE, PEEK) are flexible and can reshape upon heating, offering insulation stability in moderate temperature ranges (up to 260° C.). Like their use in substrates, thermoplastic insulation materials are configurable in thicknesses from 1 to 200 microns for either lightweight flexibility or added structural support.

Elastomeric Insulation Materials (e.g., silicone rubber, EPDM, TPEs) are valuable for applications requiring compressibility and elasticity, which help distribute compressive forces and maintain consistent contact within the stack. These materials, similar to elastomeric substrates, operate well in moderate temperatures and are available in thicknesses from 10 to 1,000 microns.

Composite Insulation Materials blend polymers with fillers like glass or ceramic, enhancing thermal and mechanical durability. Similar to composite substrates, these insulation materials support advanced thermal management in high-stress conditions, with thicknesses from 10 to 2,000 microns, depending on application needs.

Porous Insulation Materials (e.g., porous PE, PVDF) offer structured pore designs that allow compressibility for pressure uniforming and heat dissipation within the stack. Available in thicknesses from 10 to 1,500 microns, these materials offer similar functional benefits to porous substrates in promoting stability across battery layers.

High-Temperature Insulation Materials (e.g., polyimide, PEEK) are suitable for high-temperature applications (up to 350° C.) where thermal resilience is necessary, maintaining dimensional stability similar to high-temperature substrates. Thicknesses from 10 to 1,000 microns provide either flexible or rigid support as required.

Multilayer Insulation Materials use combinations of polymers such as polyimide for thermal stability, PET for flexibility, and fluoropolymers for chemical resistance. Similar to multilayer substrates, these materials are configurable from 10 to 2,000 microns, providing a customizable balance of insulation, flexibility, and stability.

Non-Polymer Electrical Insulating Layer: In addition to polymer-based options, non-polymer materials provide valuable alternatives for the electrical insulation layer, particularly in applications demanding high thermal stability, mechanical strength, and minimal thermal expansion. Ceramic materials such as alumina (Al₂O₃), aluminum nitride (AlN), and boron nitride (BN) offer excellent electrical insulation and withstand extreme temperatures, often exceeding 500° C. These ceramics are highly durable and resist chemical degradation, making them suitable for robust and high-temperature applications. Glass materials, including borosilicate glass and fused silica, provide electrical insulation and low thermal expansion, enhancing stability under thermal cycling. Another option includes mica, a natural mineral with layered structure, which provides flexibility, high dielectric strength, and stability up to 1000° C., ideal for high-voltage and high-temperature environments. For applications requiring minimal thickness, thin films of oxides like silicon dioxide (SiO₂) and titanium dioxide (TiO₂) can also serve as insulation layers, offering excellent electrical insulation while enhancing bonding with adjacent layers in the stack.

Thermally Conductive Electrically Insulating Layers: Thermally conductive electrically insulating materials can play an important role in transferring heat from the heating element to the solid-state battery (SSB) components, enhancing thermal regulation within the battery while maintaining electrical isolation. These materials support efficient heat distribution across the battery stack, which helps ensure consistent temperature management without risking electrical interference. Ceramic materials such as aluminum nitride (AlN) and boron nitride (BN) may be effective options due to their combination of high thermal conductivity and strong electrical insulation. These ceramics facilitate effective heat dissipation throughout the battery stack, stabilizing temperatures and potentially prolonging battery life. Thermally conductive polymers and composites also offer valuable flexibility; polymers filled with thermally conductive particles (e.g., AlN, BN, or magnesium oxide) achieve moderate thermal conductivity (1-5 W/m·K) while maintaining electrical insulation. Often fabricated from polyimide or silicone, these composites can be adjusted in thickness and tailored to specific thermal needs, providing a lightweight, adaptable solution. Metal oxides like magnesium oxide (MgO) and silicon carbide (SiC) may be selected for their thermal performance in high-temperature applications. MgO, with a thermal conductivity of around 60 W/m·K, effectively manages heat dissipation while remaining electrically insulating. Silicon nitride (Si₃N₄) offers a similar balance, combining high thermal conductivity with substantial mechanical strength, which is beneficial in battery systems exposed to significant thermal and mechanical stress. Hexagonal boron nitride (h-BN) is another notable material with excellent in-plane thermal conductivity (up to 400 W/m·K) and robust electrical insulation. Its layered structure facilitates efficient heat transfer across layers, making it well-suited for high-performance SSB applications.

Positioning of the Heating Element with the Solid State Battery: To support the flexible incorporation of the heating element within the solid-state battery (SSB) structure, the present design allows for various placement configurations that enhance temperature control while accommodating different battery architectures. Below is a description of potential placements and integrations of the heating element of FIG. 1 within the SSB system, ensuring proximity to the battery components that benefit most from thermal management.

1. Placement Between Current Collectors of Adjacent Cells: A primary configuration involves positioning the heating element between the current collectors of adjacent cells in a multi-cell SSB stack. This setup promotes efficient heat distribution directly to the regions where electrochemical reactions occur, aiding in the maintenance of optimal temperature conditions across the battery stack. By placing the heating element between adjacent current collectors, heat can be evenly transferred through the electrolyte layers and electrodes of each cell, improving both performance and durability under varying temperature conditions.

2. Integration with Positive or Negative Current Collector: Alternatively, the heating element may be positioned in direct proximity to either the positive or negative current collector, specifically within a single cell. In this arrangement, the heating element can help maintain a stable temperature across the active cell components, ensuring that both the positive and negative electrodes operate within optimal temperature ranges. This placement is particularly beneficial for cells that may experience localized temperature variations, helping to avoid performance fluctuations and extend the operational life of the battery.

3. Placement Adjacent to the Electrolyte Layer: The heating element can also be integrated near the solid electrolyte layer, either directly adjacent to the electrolyte or in close contact with it through an intervening insulating layer. This positioning is advantageous for ensuring consistent ionic conductivity within the electrolyte, as the ionic transport properties of solid electrolytes can be sensitive to temperature. By providing a controlled heat source near the electrolyte layer, the heating element enhances ionic mobility and overall cell efficiency, especially in low-temperature environments.

4. Encapsulation Within an Insulating Layer in the SSB Stack: In configurations where the heating element needs to be embedded within the SSB assembly, it can be encapsulated within an electrical insulation layer positioned between or adjacent to other key components, such as the electrodes or electrolyte. Encapsulation allows the heating element to provide localized heating without direct contact with other conductive layers, preventing unwanted electrical interactions while still delivering controlled thermal energy. This setup enables precise thermal management while preserving electrical isolation between components, supporting consistent performance across the stack.

5. Placement on the Exterior of the SSB Stack for Peripheral Heating: For batteries where an external heat source is advantageous, the heating element can be placed on the exterior surface of the SSB stack. In this configuration, heat is applied peripherally, allowing for gradual and uniform temperature distribution across the stack. This setup is beneficial in applications requiring a more moderate thermal increase or for preheating the battery before operation. By adjusting the design and insulating materials around the heating element, heat can be directed inward to maintain the internal temperature of the battery stack without excessive heat loss to the surrounding environment.

6. Layered Within Multi-Component Assemblies for Enhanced Heat Flow Control: For complex battery assemblies, the heating element may be integrated as one of multiple layers in a multi-component structure, with insulating and conductive materials alternately layered to control heat flow. In this structure, the heating element can deliver precise, targeted heating to select layers or cells, while other materials in the layered assembly manage heat dissipation, confinement, and thermal gradient control. This type of integrated heating configuration is valuable for high-performance applications requiring uniform temperature regulation across large or multi-layered battery assemblies.

Each of these configurations enables the heating element to adapt to the specific thermal needs of the SSB. By positioning the heating element in proximity to crucial battery components such as current collectors, electrodes, and electrolytes, the design maximizes temperature control, promoting enhanced battery efficiency, longevity, and performance across various operating conditions.

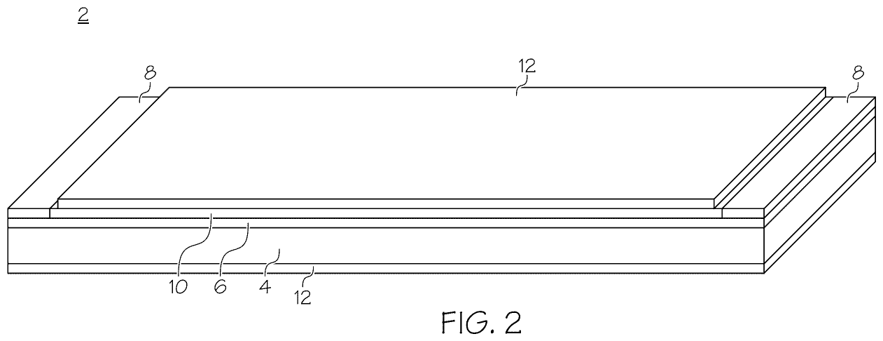

FIG. 2 illustrates an exemplary heating element (2) comprising a polymer substrate (4) having a first surface and a second surface; a conductive oxide layer (6) on the first surface of the polymer substrate; a first and second metal electrodes (8) on the conductive oxide layer; an electrical insulation layer (10) on the conductive oxide layer and positioned between the first and second metal electrodes; first and second current collectors (12) for a solid state battery disposed on the electrical insulation layer and on the second surface of the polymer substrate.

The description of FIG. 1 and its components is relied upon here, with FIG. 2 including additional elements in the form of first and second current collectors (12). These current collectors serve as interfaces within the solid-state battery (SSB) to efficiently transmit current from the battery's electrodes to the external circuit. Positioned on the electrical insulation layer and the second surface of the polymer substrate, these collectors are integral to optimizing electrical connectivity while supporting overall battery performance.

The first and second current collectors can be fabricated from various conductive materials that offer low electrical resistance and strong adhesion to adjacent layers. Suitable materials include copper, aluminum, silver, and nickel. Copper is used for its high conductivity, durability, and cost-effectiveness; it also provides excellent mechanical strength and resistance to fatigue, beneficial for long-term SSB applications. Aluminum, a lightweight and corrosion-resistant material with high electrical conductivity, is particularly suitable for applications requiring reduced weight and offers good compatibility with other battery components. Silver, known for its excellent conductivity, is ideal for applications demanding high-performance conductivity, albeit with higher cost considerations. Nickel is often used as a protective layer or as an alternative to copper in applications requiring additional corrosion resistance, offering stable performance in varied temperature conditions, which is advantageous for high-performance SSBs.

The fabrication of the current collectors (12) can be achieved through several methods, each ensuring reliable integration with the SSB components. Physical Vapor Deposition (PVD) is a vacuum-based process in which a metallic material, such as copper or aluminum, is vaporized and deposited onto the polymer substrate or insulation layer, resulting in a thin, uniform layer with excellent adhesion. Electroplating, an electrochemical process, deposits a thin metallic layer, such as copper or nickel, on the substrate, allowing for precise thickness control and cost-effectiveness for large-scale production. Screen printing, which applies conductive ink containing metallic particles (e.g., silver or copper) onto the substrate, offers a cost-effective option for producing patterned current collectors, suitable for configurations requiring custom shapes. Finally, lamination of pre-fabricated metal foils, such as aluminum or copper, onto the substrate provides a durable layer with high conductivity, ideal for SSBs that require additional mechanical support.

The current collectors (12) are designed to provide high electrical conductivity with minimal resistance loss while maintaining structural integrity under various temperature and load conditions. Material choice and fabrication technique are tailored to balance cost, conductivity, and longevity based on the specific operational requirements of the SSB. Additionally, each current collector is compatible with thermal management strategies employed in the SSB, allowing the heating element to maintain optimal battery temperatures without compromising electrical performance.

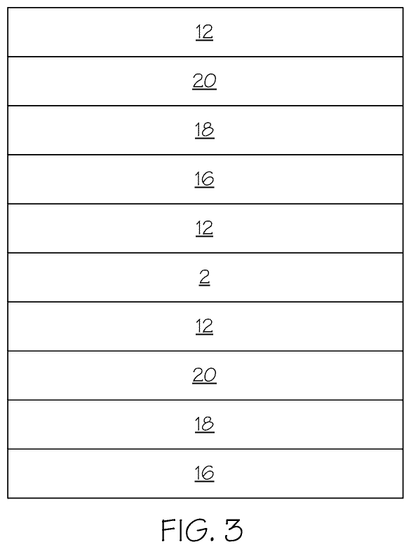

FIG. 3 illustrates a solid-state battery (14) in which a heating element (2) is positioned between adjacent current collectors (12) within a multi-cell stack. Each cell of the stack includes a positive electrode (16), a solid electrolyte layer (18), and a negative electrode (20), with the electrodes bounded on either side by current collectors (12). As shown, the heating element (2) is located between a positive and a negative current collector (12), though in other embodiments the heating element may be positioned between two positive current collectors or between two negative current collectors, depending on the stack configuration and thermal management requirements. In certain variations, the solid-state battery (14) may be implemented as an anodeless design, in which case the heating element (2) can be integrated in proximity to the current collectors to provide consistent temperature regulation even without a conventional negative electrode.

Additional variations are contemplated in which the solid electrolyte layer (18) is combined with or partially replaced by a liquid or gel electrolyte, yielding a hybrid battery architecture that nevertheless benefits from the localized heating provided by element (2). The heating element may also be incorporated into pouch, prismatic, or cylindrical formats of solid-state batteries, with placement adapted to the geometric constraints of each design. Furthermore, multiple heating elements may be distributed throughout a stack to establish zoned or redundant heating control, or may be scaled in size and resistivity to match specific application requirements such as electric vehicle propulsion, grid storage, or portable electronic devices. In all of these embodiments, positioning the heating element (2) between adjacent current collectors (12) ensures that thermal energy is delivered efficiently into the electrochemically active layers of neighboring cells, thereby enhancing ionic conductivity within the solid electrolyte (18), mitigating localized thermal gradients, and improving overall battery performance and longevity.

Beyond the configuration depicted in FIG. 3, other alternatives not illustrated are also contemplated. The heating element (2) may be integrated in proximity to a single positive or negative current collector to stabilize the temperature of an individual cell, placed adjacent to a solid electrolyte layer to promote ionic conductivity under low-temperature conditions, encapsulated within an insulating layer to provide localized heating while maintaining electrical isolation, positioned along the exterior of the stack to deliver peripheral heating, or incorporated as part of a layered assembly that combines multiple insulating and conductive components for advanced heat-flow control. These variations may be implemented individually or in combination, and further include hybrid battery designs that employ both solid and liquid electrolytes, as well as formats such as prismatic, cylindrical, or pouch cells. Each of these alternatives provides additional flexibility for incorporating the heating element (2) into solid-state battery systems, ensuring robust and adaptable thermal management across a wide range of operating conditions.

Method of Fabricating the Heating Element: In certain embodiments, a method of fabricating a heating element for use in a solid-state battery is provided. The method includes providing a polymer substrate having a first surface and a second surface, where the polymer substrate may be selected from thermoset, thermoplastic, elastomeric, composite, porous, high-temperature, or multilayer polymers, with thickness tailored to the intended application. A conductive oxide layer is then deposited on the first surface of the polymer substrate, the conductive oxide being composed of materials such as indium tin oxide (ITO), fluorine-doped tin oxide (FTO), aluminum-doped zinc oxide (AZO), antimony-doped tin oxide (ATO), vanadium oxide (VOx), or graphene oxide. Deposition may be accomplished using sputtering, physical vapor deposition, chemical vapor deposition, or by laminating a commercially available pre-coated substrate, and the thickness of the conductive oxide layer may range from a few nanometers to about one micron depending on the desired heating performance. First and second metal electrodes are subsequently formed on the conductive oxide layer to establish electrical contact points for current flow. The electrodes may be composed of copper, aluminum, silver, nickel, platinum, palladium, or combinations thereof, and can be applied by vapor deposition, sputtering, screen printing, inkjet printing, painting with conductive inks, or lamination of metallic foils. Finally, an electrical insulation layer is formed on the conductive oxide layer and positioned between the first and second metal electrodes to ensure electrical isolation while permitting efficient thermal transfer. Through these steps, a heating element is fabricated that can be readily incorporated into a solid-state battery assembly, providing controlled resistive heating to enhance the thermal management of the battery stack.

Method of Operating the Solid-State Battery: In certain embodiments, a method of operating a solid-state battery incorporating the disclosed heating element is provided. The method includes providing a solid-state battery comprising a positive electrode, a negative electrode, and a solid electrolyte positioned between them, along with a heating element disposed in proximity to at least one of the current collectors. The heating element includes a polymer substrate, a conductive oxide layer on a surface of the substrate, first and second metal electrodes on the conductive oxide layer, and an electrical insulation layer positioned between the electrodes. During operation, a voltage is applied between the first and second electrodes, causing resistive heating within the conductive oxide layer. The generated heat is transferred through adjacent layers of the solid-state battery, thereby regulating the temperature of the battery stack and improving ionic conductivity within the solid electrolyte. The temperature of the battery may be further controlled by adjusting the magnitude or duration of the applied voltage, enabling either rapid heating for cold-start conditions or sustained heating during extended operation. In embodiments where the conductive oxide layer exhibits a positive temperature coefficient of resistance, the resistance of the layer can be monitored to provide feedback on the temperature of the battery, thereby serving both as a heating element and a temperature sensor. The heating element may be positioned between current collectors of adjacent cells, in proximity to a solid electrolyte layer, or along the exterior of the battery stack, with each configuration facilitating uniform temperature distribution and enhanced electrochemical stability. In this manner, the method provides a controllable and efficient approach for managing the thermal environment of solid-state batteries, enabling improved performance, safety, and longevity across a wide range of operating conditions.

Although various embodiments of the disclosed heating element and solid-state battery configurations have been described, it will be understood by those skilled in the art that numerous modifications, variations, and alternative embodiments may be implemented without departing from the spirit or scope of the invention. The described examples highlight flexible approaches for integrating a heating element within a solid-state battery (SSB) system to optimize thermal management, ensure efficient energy use, and enhance battery longevity across a variety of applications. However, the disclosed invention is not limited to these configurations.

The materials, thicknesses, and fabrication methods for each component, such as the polymer substrate, conductive oxide layer, metal electrodes, and electrical insulation layer, can be selected and adjusted to meet specific operational needs or application environments. For instance, the choice of materials may be adapted to prioritize thermal stability, electrical conductivity, mechanical strength, or cost efficiency depending on the requirements of the SSB system. Additionally, the heating element's placement and interaction with key battery components, including current collectors, electrodes, and electrolytes, may be customized to provide targeted heating and support diverse battery architectures and operating conditions.

The invention also contemplates combinations of material properties, layered constructions, and deposition techniques that enable advanced thermal management features, including pressure distribution, heat dissipation, and dimensional stability. Further, configurations may include alternate forms of current collectors, electrical insulation layers, and conductive oxide materials that enhance flexibility and expand the design possibilities for SSB applications.

Thus, the present invention includes all such modifications, variations, and equivalents that fall within the scope of the appended claims, ensuring that the disclosed thermal management solutions are adaptable to evolving technologies and battery system requirements. The embodiments discussed are illustrative and not exhaustive, with potential enhancements, combinations, and optimizations to be explored as further developments arise in the field of solid-state battery technology.

What is claimed is:

1. A solid-state battery, comprising:
a positive electrode and a negative electrode;
a solid electrolyte layer between the positive electrode and the negative electrode;
a positive current collector in electrical contact with the positive electrode and a negative current collector in electrical contact with the negative electrode; and
a heating element in proximity to at least one of the positive current collector or the negative current collector, the heating element comprising:
a polymer substrate having a first surface and a second surface;
a conductive oxide layer on the first surface of the polymer substrate;
first and second metal electrodes on the conductive oxide layer; and
an electrical insulation layer on the conductive oxide layer and positioned between the first and second metal electrodes.

2. The solid-state battery of claim 1, wherein the polymer substrate is selected from thermoset polymers, thermoplastic polymers, elastomeric polymers, composite polymers, porous polymers, high-temperature polymers, or multilayer polymer substrates.

3. The solid-state battery of claim 1, wherein the conductive oxide layer is composed of a material selected from indium tin oxide (ITO), fluorine-doped tin oxide (FTO), aluminum-doped zinc oxide (AZO), antimony-doped tin oxide (ATO), vanadium oxide (VOx), or graphene oxide.

4. The solid-state battery of claim 1, wherein the first and second metal electrodes are formed from a material selected from copper, aluminum, silver, nickel, platinum, or palladium.

5. A heating element for a solid state battery, comprising:
a polymer substrate having a first surface and a second surface;
a conductive oxide layer on the first surface of the polymer substrate;
first and second metal electrodes on the conductive oxide layer;
an electrical insulation layer on the conductive oxide layer and positioned between the first and second metal electrodes; and
a first current collector for a solid state battery on the electrical insulation layer.

6. The heating element of claim 5, further comprising a second current collector disposed on the second surface of the polymer substrate.

7. The heating element of claim 5, wherein the polymer substrate is selected from thermoset polymers, thermoplastic polymers, elastomeric polymers, composite polymers, porous polymers, high-temperature polymers, or multilayer polymer substrates.

8. The heating element of claim 5, wherein the conductive oxide layer is composed of a material selected from indium tin oxide (ITO), fluorine-doped tin oxide (FTO), aluminum-doped zinc oxide (AZO), antimony-doped tin oxide (ATO), vanadium oxide (VOx), or graphene oxide.

9. The heating element of claim 5, wherein the first and second metal electrodes are formed from a material selected from copper, aluminum, silver, nickel, platinum, or palladium.

10. The heating element of claim 5, wherein the polymer substrate has a thickness ranging from approximately 1 micron to 1,000 microns.

11. The heating element of claim 5, wherein the conductive oxide layer has a thickness between 5 nanometers and 10 micron, depending on the required heating characteristics.

12. The heating element of claim 5, wherein the electrical insulation layer is selected from thermoset polymers, thermoplastic polymers, elastomeric polymers, composite polymers, porous polymers, high-temperature polymers, or multilayer polymer substrates.

13. The heating element of claim 5, wherein the electrical insulation layer comprises a thermally conductive, electrically insulating material selected from aluminum nitride (AlN), boron nitride (BN), magnesium oxide (MgO), or silicon carbide (SiC).

14. The heating element of claim 5, further comprising a thermally conductive, electrically insulating material in contact with the heating element to aid in heat distribution across the solid-state battery stack.

15. A method of operating a solid-state battery, comprising:
providing a solid-state battery comprising a positive electrode, a negative electrode, a solid electrolyte between the electrodes, and a heating element comprising a polymer substrate, a conductive oxide layer disposed on a first surface of the polymer substrate, first and second metal electrodes on the conductive oxide layer, and an electrical insulation layer positioned between the first and second electrodes; and
applying a voltage between the first and second electrodes to generate resistive heating in the conductive oxide layer.

16. The method of claim 15, further comprising regulating a temperature of the solid-state battery by controlling a magnitude of the applied voltage.

17. The method of claim 15, wherein the heating element is positioned between current collectors of adjacent cells in a multi-cell solid-state battery stack.

18. The method of claim 15, wherein the heating element is positioned in proximity to a solid electrolyte layer to enhance ionic conductivity.

19. The method of claim 15, wherein the conductive oxide layer exhibits a positive temperature coefficient of resistance, and further comprising monitoring the resistance of the conductive oxide layer to estimate a temperature of the solid-state battery.

20. The method of claim 15, further comprising operating the solid-state battery at sub-ambient temperatures by pre-heating the battery stack using the heating element.
